(19) United States
(12) Patent Application Publication
(10) Pub. No.: US 2007/0246637 A1
(43) Pub. Date: Oct. 25, 2007

(54) Seat of heat dissipating device

(75) Inventor: Ted Ju, Keelung City (TW)

Correspondence Address: TROXELL LAW OFFICE PLLC, SUITE 1404, 5205 LEESBURG PIKE, FALLS CHURCH, VA, 22041, US

(73) Assignee: Lotes Co., Ltd.

(21) Appl. No.: 11/402,045

(22) Filed: Apr. 12, 2006

(51) Int. Cl. F16M 7/00

(52) U.S. Cl. 248/674

(57) ABSTRACT

A heat dissipating device seat comprises a rectangular frame. At least one pair of small hook plates is formed unitizedly on the rectangular frame. A plurality of large hook plates are placed beside on the small hook plates. Because the rectangular frame comprises large hook plants, small hook plants and hooks, three standard hook devices are suitable. Besides, three standard heat dissipating fins are capable of buckling the heat dissipating device seat so as to be more interchangeable thereof.

### BACKGROUND OF THE INVENTION

(a) Field of the Invention

The present invention relates to seats of heat dissipating devices, and in particular to a seat of a heat dissipating device with multi-buckling modes.

(b) Description of the Prior Art

Generally, an operating CPU of a computer will generate heat, and the heat will increase gradually after a time period operation of the computer. In order to assure the computer operation normally, it is necessary to provide a suitable heat dissipating device so as to disperse quickly the heat generated by the operating CPU. However, a prior art of heat dissipating device is fixed to a circuit board by a seat, and the seat is installed tightly to a heat dissipating fin so as to position the bottom of the heat dissipating fin closely to the CPU so as to increase the efficiency of the heat dissipation. The prior art seat of the heat dissipating device comprises four lateral walls. The two opposite sides of the lateral walls extend out respectively to two corresponding hook plates. Each hook plate has a buckling hole. The hook portions of the two hook devices pass through respectively and hook to the corresponding hook holes of the hook plates so as to fix the heat dissipating fin to the heat dissipating device seat. However, this type of hook mode is applied only to the general heat dissipating device, not so common use in various kinds of heat dissipating devices.

Therefore, it is necessary to invent a novel type of heat dissipating devices for overcoming the above-mentioned defects.

### SUMMARY OF THE INVENTION

The primary object of the present invention is to provide a seat of a heat dissipating device suitable for a CPU with multi-standards. In order to achieve the above object, the seat of the heat dissipating device comprises a rectangular frame. At least one pair of small hook plates is formed integrally on the rectangular frame. Large hook plates are placed beside on the small hook plates.

Between the small hook plates of the above-mentioned heat dissipating device seat is installed a hook.

Comparing to prior arts, the advantage of the present invention is availably applied to multi-hook devices and multi-heat dissipating fins. Because the rectangular frame comprises large hook plants, small hook plants and hooks, three standard hook devices are suitably applied. Besides, three standard heat dissipating fins are capable of buckling the heat dissipating device seat.

### BRIEF DESCRIPTION OF THE DRAWINGS

FIG. 1 is a perspective view of the present invention.

FIG. 2 is a vertical view of the seat of the heat dissipating device of the present invention.

FIG. 3 is another perspective view of the seat of the heat dissipating device of the FIG. 1.

FIG. 4 is a front view of the heat dissipating device seat of the FIG. 1.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

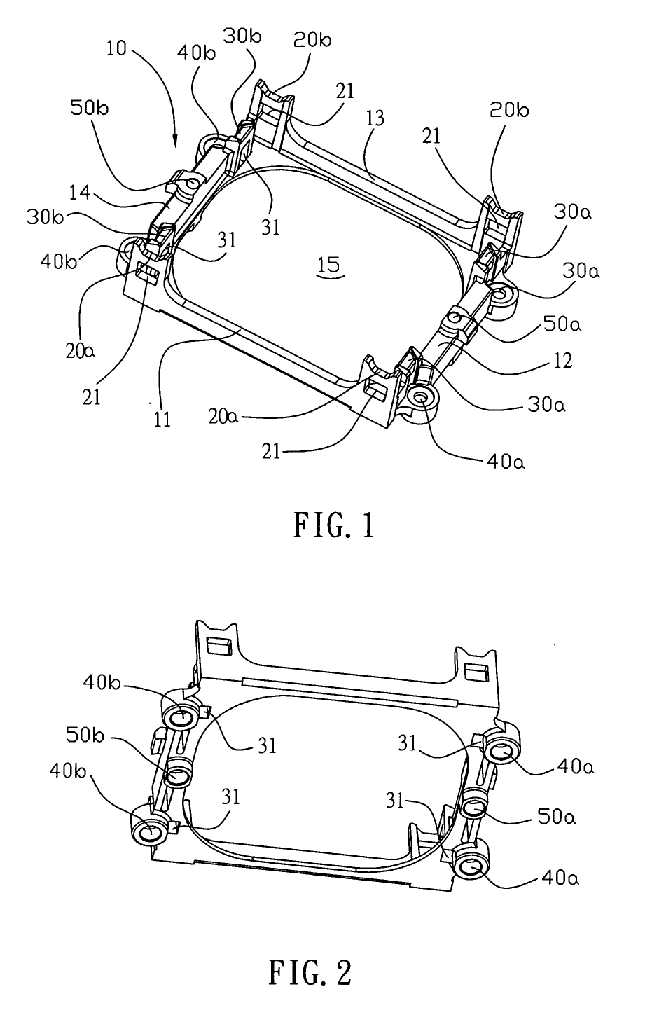

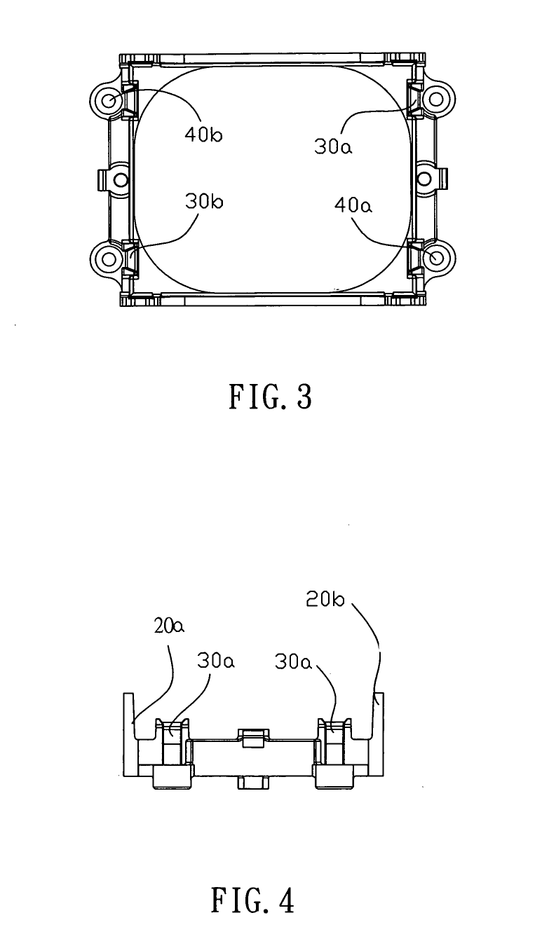

Please referring to FIGS. 1 to 4, the seat of a heat dissipating device of the present invention is illustrated. The seat is formed integrally by insulating material. The seat comprises a rectangular frame 10. The four radial protrusions of the circumference of the rectangular frame 10 are installed separately and sequentially with a first, a second, a third and a fourth lateral wall 11, 12, 13, and 14. The four lateral walls forms a receiving space 15. A heat dissipating fin is received in the receiving space 15.

The two distal ends of the first lateral wall 11 and the third lateral wall 13 at the opposite side of the first lateral wall 11 are extended with two pairs of large buckling plates 20a and 20b, respectively. The two pairs of the large buckling plates 20a and 20b are formed with first buckling holes 21. The two distal ends of the above-mentioned second lateral wall and fourth lateral wall are also installed with two pairs of small buckling plates 30a and 30b. Besides, the shapes of the small buckling plates 30a and 30b are basically identical to that of the large buckling plates 20a and 20b. However, the small buckling plate 30a and 30b are shorter than the radial height of the large buckling plates 20a and 20b. The small buckling plates 30a and 30b are also established the second buckling holes 31. The second buckling holes 31 pass through the rectangular frame 10. The interval between each pair of the small buckling plates 30a and 30b are installed respectively with buckling hooks 40a and 40b. Besides, the hook 40a and 40b are formed by extending respectively the second and the fourth lateral walls 12 and 14 of the rectangular frame 10. The hooks 40a and 40b are established on the middle portion of the second and the fourth lateral walls 12 and 14. The hooks 40a and 40b close to the second and the fourth lateral walls 12 and 14 comprise a hook portion 41. The hooks 40a and 40b are formed with first fixing holes 50a and 50b, respectively. The first fixing holes 50a and 50b are placed at the second and forth lateral walls 12 and 14 and protrude out from the bottom of the rectangular frame 10 with a predetermined distance. The two distal ends of the second and fourth lateral walls 12 and 14 are extended with two retaining portions 60a and 60b, respectively. The second retaining portions 70a and 70b are formed in the retaining portions 60a and 60b, respectively. The second fixing holes 70a and 70b is at the same level as the bottom of the fixing holes 50a and 50b.

When the present invention is assembled on a circuit board (not shown), the second fixing holes 70a and 70b should be fixed to the circuit board by using four studs (not shown) at the first step. Preventing from bending the middle portion of the heat dissipating device seat, two screw bolts (not shown) are used to fix the fixing holes 50a and 50b to the circuit board (not shown). The heat dissipating fins (not shown) are placed at the receiving space 15 of the seat of the heat dissipating device. A buckling device (not shown) serves to fix the heat dissipating fins to seat of the heat dissipating device. When the heat dissipating device dissipates heat for a CPU with the P4 standard, a heat dissipating fin (not shown) suitable to the P4 standard is placed at the receiving space 15 of the seat of the heat dissipating device. And the two hook portions (not shown) on the two sides of the hook devices suitable to the P4 standard serves to hook correspondingly and crosswise with the first fixing holes 21 on the large buckling plates 20a and 20b so as to fix the heat dissipating fins to the present invention. When the heat dissipating device is applied to the CPU of the M2 standard, the heat dissipating fin (not shown) suitable to the M2 standard should be placed at the receiving space 15 of the heat dissipating device seat. And the two hook portions (not shown) on the two sides of the hook devices suitable to the M2 standard serves to hook correspondingly and vertically with the second fixing holes 31 on the large buckling plates 30a and 30b so as to fix the heat dissipating fins to the present invention. When the heat dissipating device is applied to the CPU of the K8 standard, the heat dissipating fin (not shown) suitable to the K8 standard should be placed at the receiving space 15 of the heat dissipating device seat. And the two hook portions (not shown) on the two sides of the hook devices suitable to the K8 standard serves to hook correspondingly and laterally with the hook portion 41 of the hooks 40a and 40b so as to fix the heat dissipating fins to the present invention.

The heat dissipating device seat is strongly interchangeable so as to be applied to various heat dissipating fins with multi-standards.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A seat of a heat dissipating device comprising: a rectangular frame; the rectangular frame including at least one pair of small hook plates which is formed integrally on the rectangular frame; and a least one large hook plate being placed along the periphery of the small hook plates.

2. The seat of a heat dissipating device as claimed in claim 1, wherein a hook is installed between the each pair of small hook plates.

3. The seat of a heat dissipating device as claimed in claim 1, wherein the rectangular frame is extended with at least one fixing structure.

4. The seat of a heat dissipating device as claimed in claim 2, wherein the hook is formed with a fixing hole.

5. The seat of a heat dissipating device as claimed in claim 1, wherein the rectangular frame has a first, a second, a third and a fourth lateral wall; the large hook plates are installed on the first and the second lateral walls; and the small hook plates are installed on the second and the fourth lateral walls.

6. A seat of a heat dissipating device comprising:
a rectangular frame; at least one pair of small hook plates being formed integrally on the rectangular frame; and a hook installed installed between the pair of the small hook plates.

7. The seat of a heat dissipating device as claimed in claim 6, wherein the rectangular frame is extended with at least one fixing structure.

8. The seat of a heat dissipating device as claimed in claim 6, wherein a fixing hole is formed on the hook.
